(19) United States
(12) Patent Application Publication
(10) Pub. No.: US 2005/0125612 A1
(43) Pub. Date: Jun. 9, 2005

(54) [DEVICE CAPABLE OF INDICATING ACCESS MODES OF ACCESSIBLE MEMORY CARD]

(76) Inventors: BAR-CHUNG HWANG, HSINCHU (TW); CHIEN-YIN LIU, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,444

(22) Filed: Mar. 4, 2004

(30) Foreign Application Priority Data
Dec. 9, 2003 (TW) 92221612

(51) Int. Cl. G06F 13/28

(52) U.S. Cl. 711/115

(57) ABSTRACT

A device capable of indicating access modes for an accessible memory card comprises an indicator and an interface electrically connected to a controller of the accessible memory card and to the indicator. The indicator is driven by the interface to show users that the accessible memory card is performing an access operation when the controller gives commands to the accessible memory card.

### CROSS REFERENCE TO RELATED APPLICATIONS

This application claims the priority benefit of Taiwan application serial no. 92221612, filed on Dec. 9, 2003.

### BACKGROUND OF INVENTION

1. Field of the Invention

The present invention relates to an access indication device. More particularly, the present invention relates to a device capable of indicating access modes for an accessible memory card.

2. Description of the Related Art

At present, most accessible memory cards are flash memory cards. The main storage device thereof can be a flash memory or a flash read-only memory (flash ROM). However, the material constituting the latest flash ROM differs considerably from that constituting the earlier ROM. Flash memory was launched by Intel in the 1980s to replace electrically erasable programmable read-only memory (EEPROM) as a code storage device. The flash memory is on the merit of fast access of instructions and the management of system initialization. Data can be saved in the flash memory even when the power source is cut off. Data refresh operation of the flash memory is carried out block by block instead of byte by byte. In general, each block contains data with the capacity ranging from 512 bytes to 2 kilobytes, for example.

The flash memory evolved from the electrically erasable programmable read-only memory (EEPROM). Because the flash memory has a lower price and a higher bit density, it is a substitute for the EEPROM. Nowadays, the flash memory can be adapted for a PC, a main board, or a smart card. With the increase in writing speed, the need for high storage capacity device and the drop in price per bit of memory in recent years, a main trend that voice and image data (for example, MP3) are saved by the flash memory card appears turned into.

Flash memory has three major types of architectures, namely, NOR, NAND and EE-NOR, varying with one another in technology.

The NOR memory was unveiled by Intel. It has a faster reading rate and can write and read instructions to and from block units with a higher operating voltage, a longer erase time and a larger amount of erase blocks. This type of product is mainly used for storing and accessing program codes or applied to a PC memory card. In the beginning of 1998, Intel launched a flash memory with multi level cell technique (the so-called Strata Flash). The strata flash memory has a larger memory storage capacity for data storage.

The NAND memory was unveiled by Toshiba. The NAND memory has a slower accessing rate but has a smaller area of each memory cell. The NAND memory has a lower production cost than that of the NOR memory upon the same density. Hence, the NAND memory is particular suitable for a product requiring a high storage capacity. In a portable device, the storage product with the NAND memory can replace the hard disk. The NAND memory acts as a data storage device for a consumer electronic product.

The EENOR memory is an improved version of the NOR memory. Data can be accessed through a smaller memory cell. The operating speed of the memory is not only increased, but the operation can also be carried out at a lower voltage or power. Due to the EENOR having a high speed like a NOR memory and adapted to save instructions for a PC, it has a short instruction accessing period. The EENOR memory is widely used in portable and wireless communication products due to its low operation voltage and power.

However, the flash memory card permits data to be written in physical layer with no limit of the length of the data. In the data write-in operation, a control IC within a memory card performs the repetition of a set of steps of copying, updating, erasing and so on.

In general, a data access device can light up an indicator or display a hint on a screen for warning a user not to unplug the memory card during write-in operation. FIG. 1 is a schematic diagram of a conventional data access device for memory cards. As shown in FIG. 1, a multi-functional flash memory card is suited for being inserted into the access device 10. The data access device 10 has four memory card slots including an MS memory cord slot 12-1, an SD/MMC memory card slot 12-2, an SM memory card slot 14, and a CF memory card slot 16. The memory card slots 12-1 and 12-2 are interchangeable slots.

However, the access indicating light or the screen for showing messages about the operation of some memory card may not be located near the card, especially for the above-mentioned multi-card data access device. Moreover, the indicating light of the multi-card data access device 10 as shown in FIG. 1 may be blocked by the nearby memory card. During the on-going accessing operation of a particular memory card, a user may be unaware of unplugging the memory card, leading some or all of the data to be destroyed and causing some serious damages.

### SUMMARY OF INVENTION

Accordingly, an objective of the present invention is to provide a device for indicating access modes for an accessible memory card so that a user can recognize whether the accessible memory card is accessing.

At least a second objective of the present invention is to provide an indicator on a memory card such that a user can clearly see which memory card is being accessed. Hence, unplugging the memory card that is being accessed can be avoided.

To achieve these and other advantages, the invention provides a device for indicating access modes for an accessible memory card. The device comprises an indicator and an interface. The interface is electrically connected to a controller of an accessible memory card and the indicator. The indicator is driven by the interface to show users that the accessible memory card is performing an access operation when the controller gives commands to operate the accessible memory card.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional data access device for accessible memory cards.

FIG. 2 is a block diagram showing the relationship between a data access device and an accessible memory card according to the present invention.

FIG. 3 is diagram showing an accessible memory card according to the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

The present invention mainly provides a device for indicating access modes for an accessible memory card. The device comprises an indicator and an interface. The interface is electrically connected to a card controller of the accessible memory card and the indicator. The indicator is driven by the interface to show users that the accessible memory card is performing an access operation when the card controller gives commands to operate the accessible memory card. The accessible memory card can be a type I/II compact flash (CF) card, a smart media (SM) card, a memory stick (MS) card, a multimedia card (MMC), a secure digital (SD) card or a micro drive.

The commands issued from the card controller may include a “write” command, a “read” command and an “erase” command. Correspondingly, the operations performed by the accessible memory card may include a writing operation, a reading operation and an erasing operation. When the card controller issues a “write” command to the accessible memory card for performing a writing operation, the indicator indicates that the accessible memory card is performing a writing operation. When the card controller issues a “read” command to the accessible memory card for performing a reading operation, the indicator indicates that the accessible memory card is performing a reading operation. When the card controller issues an “erase” command to the accessible memory card for performing an erasing operation, the indicator indicates that the accessible memory card is performing an erasing operation.

The aforementioned indicator comprises a light-emitting diode for indicating the on-going operation of the accessible memory card, such as a writing operation, a reading operation or an erasing operation. Alternatively, two or more light-emitting diodes can be deployed on the accessible memory card to indicate the respective on-going operation of the accessible memory card.

The aforementioned interface comprises a determination device for determining which command issued from the card controller and a driver for driving the indicator. The aforementioned accessible memory card further comprises an external interface for electrically connecting with a host machine.

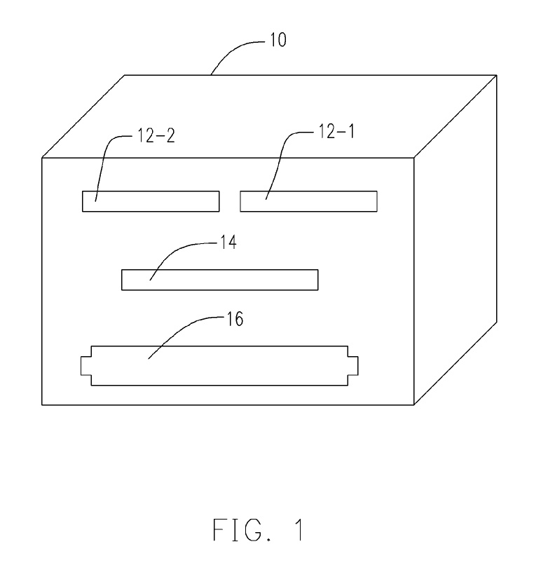

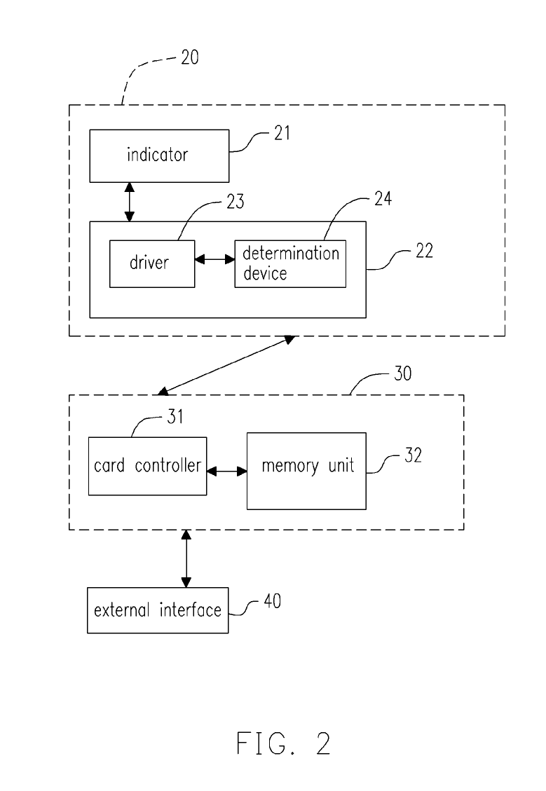

FIG. 2 is a block diagram showing the relationship between a data access device and an accessible memory card according to the present invention. As shown in FIG. 2, the device 20 for indicating access modes for an accessible memory card comprises an indicator 21 and an interface 22. The interface 22 further comprises a driver 23 and a determination device 24. An accessible memory card 30, such as flash memory card, comprises a card controller 31 and a memory unit 32. Through an external interface 40, the accessible memory card 30 can connect with a host or a card reader as shown in FIG. 1 for transmitting data.

When the card controller 31 receives a protocol transmitted from the card reader via the external interface 40, a command is transmitted to the memory unit 32. Since the interface 22 is electrically connected to the accessible memory card 30, the determination device 24 can also pick up the command sent from the card controller 31. The types of commands issued from the card controller 31 may include a “copy” command, a “read” command or an “erase” command. In general, different types of flash memory card 30 may use different protocols to indicate the same command. For example, SD card uses CMD17 and CMD18 to indicate a “read” command and CMD24 and CMD25 to indicate a “write” command. According to these commands, the memory unit 32 performs a reading operation, a writing operation or an erasing operation.

When the determination device 24 receives the command issued from the card controller 31, the driver 23 drives the indicator 21. In this embodiment, the indicator 21 can be a light-emitting diode (LED). Furthermore, the indicator 21 can perform operations according to the command received by the determination device 24. For example, continuous lighting of the light-emitting diode may indicate the memory card performing a writing operation; rapid flashing of the light-emitting diode may indicate the memory card performing a reading operation; slow flashing of the light-emitting diode may indicate the memory card performing an erasing operation. Alternatively, in case that the indicator 21 is constructed from two light-emitting diodes, such as a green diode and a red diode, the lighting of the red diode may indicate the memory card performing a writing operation, the lighting of the green diode may indicate the memory card performing a reading operation, and the simultaneous lighting of the red and the green diodes indicates the memory card performing an erasing operation. Alternatively, in case that the indicator 21 is constructed from a single light-emitting diode capable of generating at least two colors, different colors may indicate a specific operation, relatively. The aforementioned three embodiments of the indicator 21 are possible examples, but the indicator 21 is not limited to the above-mentioned three types.

In general, different types of memory cards are performed with different commands. The determination device 24 can request the driver 23 to drive the indicator 21 according to the commands issued from all kinds of memory cards. In addition, the driver 23 may drive all kinds of indicators 21 to achieve the indicating purpose.

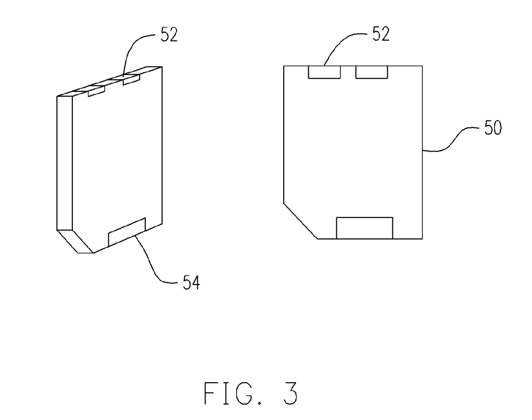

FIG. 3 is a diagram showing an accessible memory card according to the present invention. Referring to FIG. 3, a memory card 50 has light-emitting diodes 52 serving as an indicator 21. The contacts 54 are located at one side of the memory card 50 while the light-emitting diodes 52 are located at the opposite side of the memory card 50. The contacts 54 are the external interface 40 shown in FIG. 2 and the light-emitting diodes 52 are the indicator 21 shown in FIG. 2. As shown in FIG. 3, the light-emitting diodes 52 has a transparent or semi-transparent enclosure and can emit the light from three surfaces so that a user can easily observe the diodes from all angles and can recognize whether the memory card 50 is accessing.

In conclusion, the present invention provides a device suited for clearly indicating access modes for a memory card so that a user can lucidly see what all of the memory cards inserted into the data access device are going on. Hence, unplugging the being-accessed memory card can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A device capable of indicating access modes for an accessible memory card, comprising:
an indicator; and
an interface electrically connected to a card controller of the accessible memory card and to the indicator, wherein the indicator is driven by the interface to show users that the accessible memory card is performing an accessing operation when the card controller issues commands to operate the accessible memory card.

2. The device of claim 1, wherein the accessible memory card is selected from a group consisting of a compact flash (CF) card, a memory stick (MS) card, a multimedia card (MMC) and a secure digital card.

3. The device of claim 1, wherein the command issued from the card controller is selected from a group consisting of a “write” command, a “read” command and an “erase” command.

4. The device of claim 3, wherein the accessible memory card performs operation selected from a group consisting of a writing operation, a reading operation and an erasing operation, and the accessible memory card carries out a writing operation when the card controller issues a “write” command, and the accessible memory card carries out a reading operation when the card controller issues a “read” command, and the accessible memory card carries out an erasing operation when the card controller issues an “erase” command.

5. The device of claim 4, wherein when the card controller issues a “write” command, the indicator indicates that the accessible memory card is performing a writing operation.

6. The device of claim 5, wherein the indicator further comprises at least a first light-emitting diode for indicating that the accessible memory card is performing a writing operation.

7. The device of claim 4, wherein when the card controller issues a “read” command, the indicator indicates that the accessible memory card is performing a reading operation.

8. The device of claim 7, wherein the indicator further comprises at least a second light-emitting diode for indicating that the accessible memory card is performing a reading operation.

9. The device of claim 4, wherein when the card controller issues an “erase” command, the indicator indicates that the accessible memory card is performing an erasing operation.

10. The device of claim 9, wherein the indicator further comprises at least a third light-emitting diode for indicating that the accessible memory card is performing a erasing operation.

11. The device of claim 4, wherein the indicator comprises a light-emitting diode for indicating that the accessible memory card is performing a reading operation.

12. The device of claim 11, wherein the light-emitting diode can be used for further indicating that the accessible memory card is performing an erasing operation.

13. The device of claim 11, wherein the light-emitting diode can be used for further indicating that the accessible memory card is performing a writing operation.

14. The device of claim 4, wherein the said interface further comprises a determination device for determining the command issued from the card controller.

15. The device of claim 4, wherein the interface further comprises a driver for driving the indicator.

16. The device of claim 1, wherein the interface further comprises a determination device for determining the command issued from the card controller.

17. The device of claim 1, wherein the interface further comprises a driver for driving the indicator.

18. The device of claim 1, wherein the accessible memory card further comprises an external interface for connecting the accessible memory card with a host machine.
